(19) United States
(12) Patent Application Publication
(10) Pub. No.: US 2025/0159363 A1
(43) Pub. Date: May 15, 2025

(54) SEMICONDUCTOR DEVICE

(71) Applicant: Renesas Electronics Corporation, Tokyo (JP)

(72) Inventors: Kazuaki TERASHIMA, Tokyo (JP); Isao NAGAYOSHI, Tokyo (JP)

(21) Appl. No.: 18/925,421

(22) Filed: Oct. 24, 2024

(30) Foreign Application Priority Data
Nov. 15, 2023 (JP) 2023-194724

(51) Int. Cl. H04N 23/80; H04N 23/60

(52) U.S. Cl. CPC H04N 23/80; H04N 23/665

(57) ABSTRACT

A semiconductor device capable of verifying whether or not correct acquirement of image data from a sensor has been successful is provided. A semiconductor device includes: a reception interface circuit receiving a plurality of packets including a plurality of line data, respectively, and outputting an image composite signal generated by linking a line synchronization signal with each of the plurality of line data; and a capture circuit provided at a subsequent stage of the reception interface circuit. The capture circuit includes: a line counter receiving, as its input, the line synchronization signal included in the image composite signal, and counting the number of times of the input of the line synchronization signal; and a comparator comparing a count value counted by the line counter with a preset expected value of the number of lines, and outputting an error signal if the count value and the expected value do not match each other.

### CROSS-REFERENCE TO RELATED APPLICATION

The disclosure of Japanese Patent Application No. 2023-194724 filed on Nov. 15, 2023, including the specification, drawings and abstract is incorporated herein by reference in its entirety.

### BACKGROUND

The present invention relates to a semiconductor device, and relates to, for example, a semiconductor device that performs image processing.

There is disclosed technique listed below.
[Patent Document 1] Japanese Unexamined Patent Application Publication No. 2010-86401

The Patent Document 1 discloses a microcomputer capable of capturing data in different regions in parallel and transferring the captured data to a storage circuit. The microcomputer includes:

a direct RAM interface (DRI) that captures image data in a predetermined region from among image data from a camera and transfers the captured image data to a memory block; and a CPU that controls the DRI to transfer the respective image data in the different regions among the image data from the camera, to the memory block.

### SUMMARY

For example, an interface circuit based on MIPI (Mobile Industry Processor Interface) CSI-2 (Camera Serial Interface 2) standards or the like packetizes and transmits/receives line data made of image data such as RAW data generated by a sensor, meta data, and the like. The image data included in the received packet is stored in, for example, a memory for each line, and is processed by an ISP (Image Signal Processor), a CPU (Central Processing Unit), or the like.

Under such circumstances, for example, when any abnormality occurs in a path extending from the sensor and a transmission interface circuit to a reception interface circuit, the insufficient/excessive line data is formed, and the image data stored in the memory may be more deteriorated than image data to be an image-processing target originally acquired and processed by the sensor. In this case, the ISP, the CPU, or the like performs the image processing on the basis of the deteriorated image data. Particularly, in an in-vehicle system such as ADAS (Advanced Driver Assistance Systems), image recognition based on the image data or the like is performed in order to achieve functional safety. Therefore, the image recognition processing needs to use non-deteriorated image data.

Embodiments described below have been made in view of such circumstances, and other problems and novel characteristics will be apparent from the description of the present specification and the accompanying drawings.

A semiconductor device according to an embodiment includes: a reception interface circuit receiving a plurality of packets each including line data and outputting an image composite signal generated from linkage of a line synchronization signal with each of the plurality of line data; and a capture circuit provided at a subsequent stage of the reception interface circuit. The capture circuit includes: a line counter receiving the line synchronization signal included in the image composite signal as its input and counting the number of times of the input of the line synchronization signal; and a comparator comparing a count value counted by the line counter with a preset expected value of the number of lines, and outputting an error signal when the count value and the expected value do not match each other.

By use of the semiconductor device according to the embodiment, it can be verified whether or not acquirement of image data from a sensor has been correctly executed.

### BRIEF DESCRIPTIONS OF THE DRAWINGS

FIG. 1 is a schematic diagram illustrating a configuration example of an image processing system using a semiconductor device according to a first embodiment;

FIG. 2 is a schematic diagram illustrating a configuration example of a packet received by a reception interface circuit in FIG. 1;

FIG. 3 is a timing chart illustrating a conceptual configuration example of an image composite signal output by the reception interface circuit in FIG. 1;

FIG. 4A is a circuit block diagram illustrating a configuration example of a capture circuit illustrated in FIG. 1;

FIG. 4B is a circuit block diagram illustrating a configuration example of a monitor circuit illustrated in FIG. 4A;

FIG. 5 is a schematic diagram illustrating a configuration example of a packet received by the reception interface circuit illustrated in FIG. 1 in a semiconductor device according to a second embodiment;

FIG. 6 is a timing chart illustrating a conceptual configuration example of an image composite signal output by the reception interface circuit illustrated in FIG. 1 in the semiconductor device according to the second embodiment;

FIG. 7A is a circuit block diagram illustrating a configuration example of the capture circuit illustrated in FIG. 1 in the semiconductor device according to the second embodiment;

FIG. 7B is a schematic diagram illustrating an example of a content held in a setting register illustrated in FIG. 7A;

FIG. 8 is a timing chart illustrating a main operation example of a monitor circuit illustrated in FIG. 7A;

FIG. 9 is a diagram illustrating a configuration example of a packet received by the reception interface circuit illustrated in FIG. 1 and a configuration example of an image composite signal output by the reception interface circuit in a semiconductor device according to a third embodiment;

FIG. 10 is a circuit block diagram illustrating a configuration example of the capture circuit illustrated in FIG. 1 in the semiconductor device according to the third embodiment;

FIG. 11 is a timing chart illustrating an operation example of a line division circuit illustrated in FIG. 10;

FIG. 12 is a diagram illustrating a configuration example of a packet received by the reception interface circuit illustrated in FIG. 1 and a configuration example of an image composite signal output by the reception interface circuit in a semiconductor device according to a fourth embodiment;

FIG. 13 is a circuit block diagram illustrating a configuration example of the capture circuit illustrated in FIG. 1 in the semiconductor device according to the fourth embodiment; and

FIG. 14 is a timing chart illustrating a main operation example of a monitor circuit illustrated in FIG. 13.

### DETAILED DESCRIPTION

In the embodiments described below, the invention will be described in a plurality of sections or embodiments when required as a matter of convenience. However, these sections or embodiments are not irrelevant to each other unless otherwise stated, and the one relates to the entire or a part of the other as a modification example, details, or a supplementary explanation thereof. Also, in the embodiments described below, when referring to the number of elements (including number of pieces, values, amount, range, and the like), the number of the elements is not limited to a specific number unless otherwise stated or except the case where the number is apparently limited to a specific number in principle. The number larger or smaller than the specified number is also applicable. Further, in the embodiments described below, it goes without saying that the components (including element steps) are not always indispensable unless otherwise stated or except the case where the components are apparently indispensable in principle. Similarly, in the embodiments described below, when the shape of the components, positional relation thereof, and the like are mentioned, the substantially approximate and similar shapes and the like are included therein unless otherwise stated or except the case where it is conceivable that they are apparently excluded in principle. The same goes for the numerical value and the range described above.

Hereinafter, embodiments will be described in detail with reference to the accompanying drawings. Note that components having the same function are denoted by the same reference symbols throughout all the drawings for describing the embodiments, and the repetitive description thereof will be omitted. In the following embodiments, description of the same or similar portions is not repeated in principle except when particularly necessary.

### FIRST EMBODIMENT

### Outline of Semiconductor Device

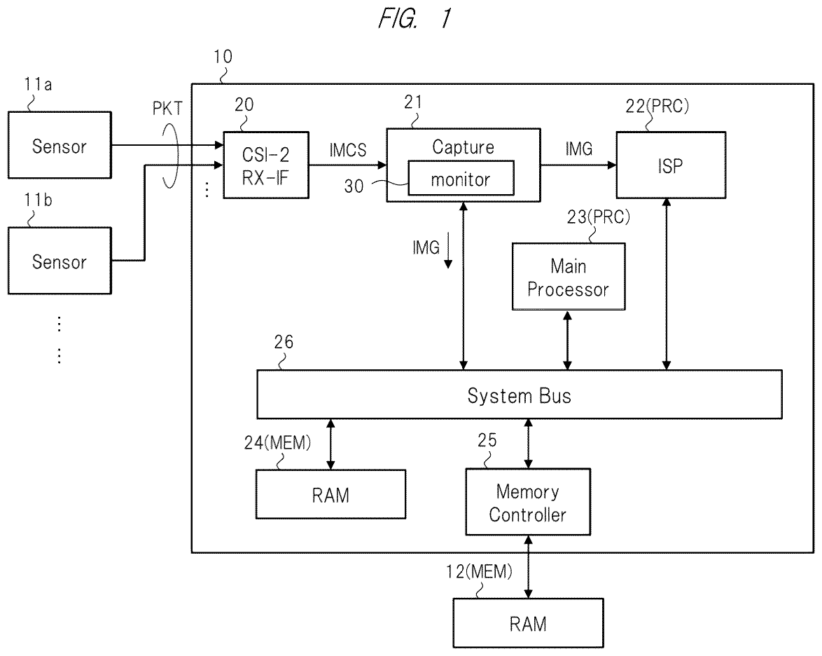

FIG. 1 is a schematic diagram illustrating a configuration example of an image processing system using a semiconductor device according to a first embodiment. The image processing system is, for example, an in-vehicle system such as an ADAS. The image processing system includes a plurality of sensors 11a, 11b and . . . , a semiconductor device 10, and a RAM (Random Access Memory) 12 as an external memory. In the specification, the plurality of sensors 11a, 11b and . . . are collectively referred to as a sensor 11. The RAM 12 is, for example, a DRAM (Dynamic RAM). The sensor 11 is, for example, an image sensor and a ranging sensor.

The image sensor includes CMOS (Complementary Metal Oxide Semiconductor)-type or CCD (Charge Coupled Device)-type imaging elements arranged in a matrix pattern. The image sensor generates captured image data based on imaging using the imaging elements. Meanwhile, the ranging sensor includes, for example, a radar. The ranging sensor generates distance image data based on distance measurement using the radar. In the specification, the captured image data and the distance image data are collectively referred to as image data IMG.

The sensor 11 further includes a transmission interface circuit. The transmission interface circuit is, for example, a circuit having various functions based on the MIPI CSI-2 standards. As a result, the sensor 11 packetizes the line data functioning as the image data corresponding to one line, and transmits a plurality of packets PKT each including the line data.

The semiconductor device 10 is, for example, an in-vehicle LSI (Large Scale Integration) such as an SoC (system on a Chip) or a microcontroller made of a single semiconductor chip. The semiconductor device 10 performs, for example, image processing or image recognition processing to the image data included in each of the packets output from the sensor 11. The semiconductor device 10 includes a reception interface circuit 20, a capture circuit 21, an ISP 22, a main processor 23, a RAM 24 functioning as an internal memory, a memory controller 25, and a system bus 26.

The system bus 26 connects the capture circuit 21, the ISP 22, the main processor 23, the RAM 24, and the memory controller 25 to one another. The RAM 24 is, for example, an SRAM (Static RAM) or others. The memory controller 25 controls access to the RAM 12 functioning as an external memory. In the specification, each of the RAM 24 and the RAM 12 is merely referred to as a MEM, unless otherwise being particularly required to be distinguished. Although not illustrated, the semiconductor device 10 further includes a nonvolatile memory storing a program or the like.

The reception interface circuit 20 is, for example, a circuit having various functions based on the MIPI CSI-2 standards. The reception interface circuit 20 receives the plurality of packets PKT from the sensor 11. Each of the plurality of packets PKT includes the line data as described above. Although described in detail later, the reception interface circuit 20 links a horizontal synchronization signal with each of the plurality of line data, and outputs an image composite signal IMCS generated based on the linkage.

The capture circuit 21 is provided at a later stage of the reception interface circuit 20, and receives the image composite signal IMCS as its input from the reception interface circuit 20. The capture circuit 21 sequentially writes each piece of the line data included in the image composite signal IMCS into the memory MEM. More specifically, the capture circuit 21 extracts image data IMG from each piece of the line data. That is, each piece of the line data may include various types of additional information in addition to the image data IMG. The capture circuit 21 extracts the image data IMG by removing such additional information, and writes the extracted image data IMG into the memory MEM.

To the ISP 22, the capture circuit 21 transfers the image data IMG based on a preset content, such as the image data IMG on a specific channel, as required. Further, the capture circuit 21 includes a monitor circuit 30 for monitoring the image data IMG. Note that details of the capture circuit 21 will be described later.

The ISP 22 performs image processing such as demosaic processing, HDR (High Dynamic Range) image generation processing, black level correction processing, and color space conversion processing, to the image data IMG stored in the memory MEM or the image data IMG transferred from the capture circuit 21. The ISP 22 writes the image-processed image data into the memory MEM.

In the demosaic processing, for example, the ISP 22 generates the image data having an RGB format, a YUV format, or the like by performing a processing for interpolating a pixel value having a missing color to the image data IMG such as RAW data based on, for example, a Bayer layout. In the HDR image generation processing, the ISP 22 generates an HDR image by synthesizing images respectively captured with a plurality of exposure amounts (exposures) or the like.

The main processor 23 includes a CPU, and is configured by appropriately combining a DSP (Digital Signal Processor), a GPU (Graphics Processing Unit), or the like with the CPU. The main processor 23 controls a processing sequence of the entire semiconductor device 10 while appropriately cooperating with various internal circuits included in the semiconductor device 10 by executing a program stored in the RAM 24 or the like. The processing to be performed by the main processor 23 includes image recognition processing such as object detection processing using a neutral network. In the specification, the ISP 22 and the main processor 23 are collectively referred to as a processor PRC.

### Outline of Reception Interface Circuit

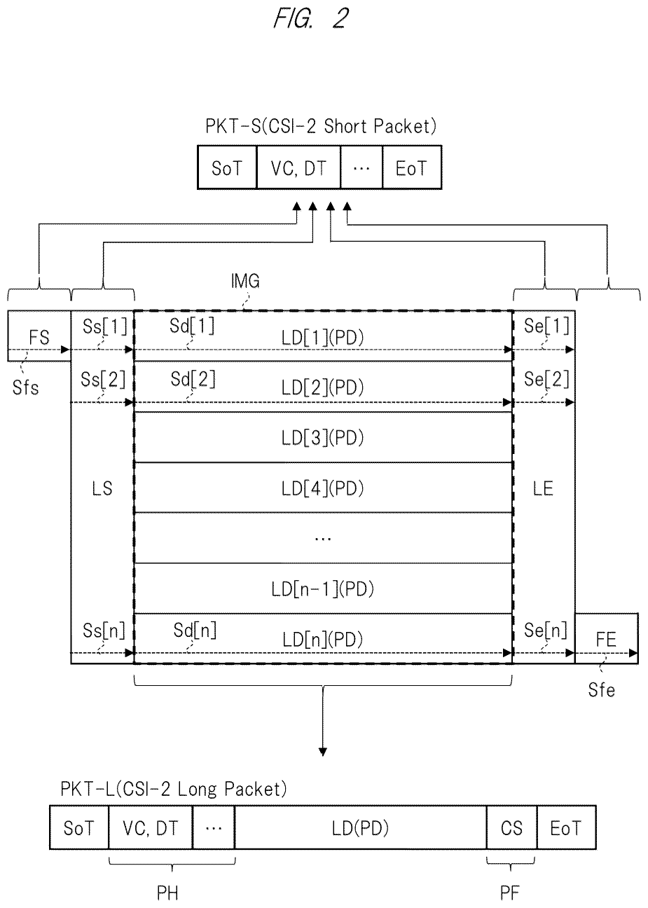

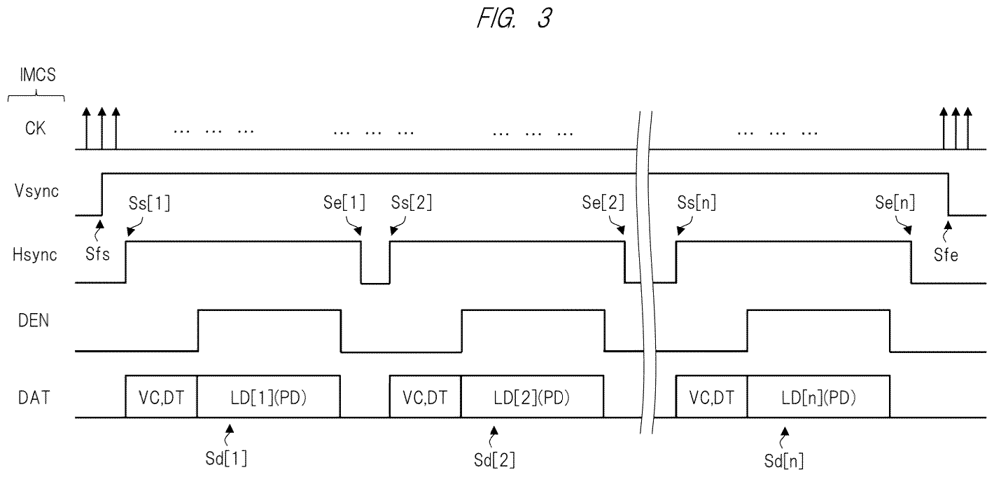

FIG. 2 is a schematic diagram illustrating a configuration example of the packet PKT received by the reception interface circuit 20 in FIG. 1. FIG. 3 is a timing chart illustrating a conceptual configuration example of an image composite signal IMCS output from the reception interface circuit 20 in FIG. 1. As illustrated in FIG. 2, in the MIPI CSI-2 standards, a short packet PKT-S and a long packet PKT-L are defined.

The short packet PKT-S is a packet for, for example, notifying FS (frame start)/FE (frame end) and LS (line start)/LE (line end). The FS/FE represents start/end of the image data IMG. The LS/LE represents start/end of each of pieces LD[1] to LD[n] of the line data of “n” lines included in the image data IMG.

Here, the line data LD[1] is data of the first line configuring the image data IMG, and includes a plurality of pixel data PD. Similarly, the line data LD[n] is data of the n-th line configuring the image data IMG, and includes a plurality of pixel data PD. The short packet PKT-S includes a value of a virtual channel (VC) and a value of a data type (DT). For example, each of the sensors 11 is identified by the value of the virtual channel (VC), and the FS/FE, the LS/LE, or the like is identified by the value of the data type (DT).

On the other hand, the long packet PKT-L is a packet for transmitting each of piece LD[1] to LD[n]s of the line data of the n lines included in the image data IMG. The long packet PKT-L is formed by adding a packet header PH and a packet footer PF or the like to the line data LD. The packet header PH includes a value of a virtual channel (VC) and a value of a data type (DT), as similar to the short packet PKT-S. For example, an image format type such as RAW data or RGB data, the number of bits of one pixel, or the like is identified by the value of the data type (DT). As the packet footer PF, for example, a checksum CS or the like is stored.

FIG. 2 illustrates an order of the packets PKTs received by the reception interface circuit 20. The reception interface circuit 20 first receives FS made of the short packet PKT-S (step Sfs). Then, the reception interface circuit 20 sequentially receives the LS made of the short packet PKT-S, the line data LD[1] of the first line to be loaded into the long packet PKT-L, and the LE made of the short packet PKT-S (steps Ss[1], Sd[1], and Se[1]).

Then, the reception interface circuit 20 sequentially receives the LS made of the short packet PKT-S, the line data LD[2] of the second line to be loaded into the long packet PKT-L, and the LE made of the short packet PKT-S (steps Ss[2], Sd[2], and Se[2]). Similarly, hereinafter, the reception interface circuit 20 receives the line data to the line data LD[n−1] of the “n−1”-th line.

Then, the reception interface circuit 20 sequentially receives the LS made of the short packet PKT-S, the line data LD[n] of the n-th line to be loaded into the long packet PKT-L, and the LE made of the short packet PKT-S (steps Ss[n], Sd[n], and Se[n]). At the end, the reception interface circuit 20 receives the FE made of the short packet PKT-S (step Sfe). Note that the image data IMG is, for example, captured image data generated by the image sensor.

The reception interface circuit 20 receives such a packet PKT, and conceptually outputs the image composite signal IMCS as illustrated in FIG. 3. The image composite signal IMCS includes, for example, a clock signal CK, a frame synchronization signal Vsync, a line synchronization signal Hsync, a data enable signal DEN, and a data signal DAT. The reception interface circuit 20 asserts the frame synchronization signal Vsync in accordance with the FS, and negates the frame synchronization signal Vsync in accordance with the FE. As a result, the reception interface circuit 20 links the frame synchronization signal Vsync with the whole of the plurality of line data LD[1] to LD[n].

The reception interface circuit 20 asserts the line synchronization signal Hsync in accordance with the LS, and negates the line synchronization signal Hsync in accordance with the LE. As a result, the reception interface circuit 20 links the line synchronization signal Hsync with each of pieces LD[1] to LD[n] of the line data of the n lines. Note that the LS/LE may not be generated depending on a specification. In this case, the reception interface circuit 20 asserts the line synchronization signal Hsync in accordance with the packet header PH in the long packet PKT-L, and negates the line synchronization signal Hsync in accordance with the packet footer PF.

In addition to the line data LD[1] to LD[n], the reception interface circuit 20 outputs, for example, the value of the virtual channel (VC) and the value of the data type (DT) that are added to each piece of the line data LD as the data signal DAT. When outputting the line data LD[1] to LD[n], the reception interface circuit 20 asserts the data enable signal DEN and outputs the line data LD[1] to LD[n] within assert periods of the data enable signal DEN.

Note that the transmission interface circuit based on the MIPI-CSI2 standards is also more specifically a serializer, and serially transmits the line data LD by using four lanes or the like. On the other hand, the reception interface circuit 20 is also a deserializer, and converts the line data LD that has serially transmitted by using the four lanes or the like into parallel data. Accordingly, the data signal DAT is specifically a parallel signal. The image composite signal IMCS can include various control signals or the like caused by such serial-parallel conversion.

In the above-described configuration, for example, when any abnormality occurs in a path leading from the sensor 11 to the reception interface circuit 20, the number of lines of the line data LD included in the image composite signal IMCS may be made excess/insufficient. If the capture circuit 21 writes such line data LD and thus the pixel data PD to the memory MEM as it is, the image data IMG stored in the memory MEM may be more deteriorated than the image data to be expected as the image processing target. As a result, it is concerned that the processor PRC performs the image processing or the image recognition processing on the basis of the deteriorated image data. Therefore, it is useful to use the capture circuit 21 as described below.

### Details of Capture Circuit

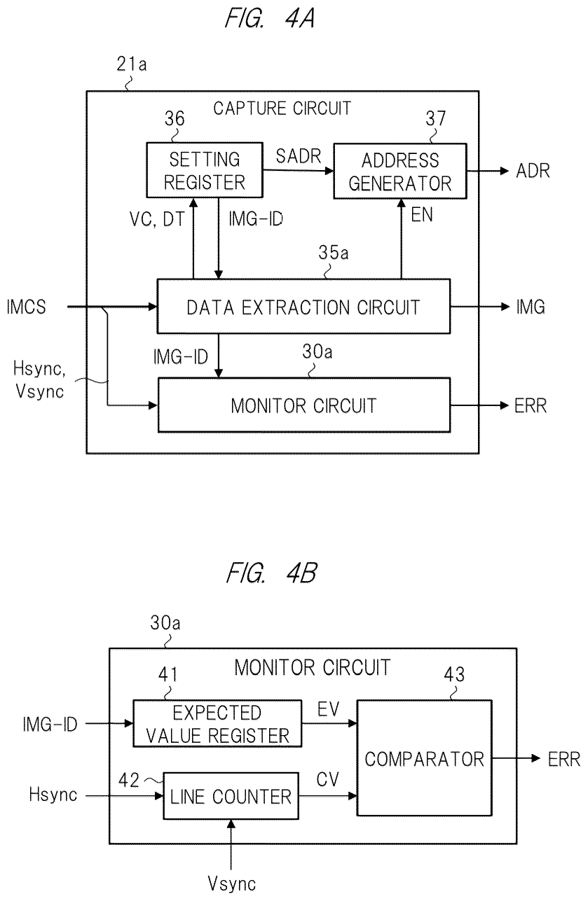

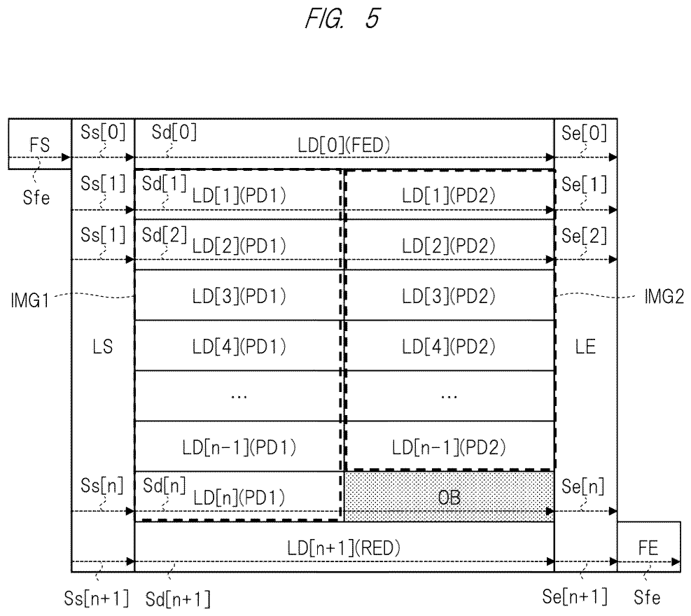

FIG. 4A is a circuit block diagram illustrating a configuration example of the capture circuit 21 illustrated in FIG. 1. FIG. 4B is a circuit block diagram illustrating a configuration example of a monitor circuit 30a illustrated in FIG. 4A. A capture circuit 21a illustrated in FIG. 4A includes the monitor circuit 30a, a data extraction circuit 35a, a setting register 36, and an address generator 37. The data extraction circuit 35a receives the image composite signal IMCS as its input, and extracts the pixel data PD and thus the image data IMG from each of the plurality of line data LD on the basis of a preset rule.

Specifically, the data extraction circuit 35a refers to the setting register 36 by using the value of the virtual channel (VC) and the value of the data type (DT) that are included in the image composite signal IMCS. In the setting register 36, an image identifier IMG-ID is previously linked with a combination of the value of the virtual channel (VC) and the value of the data type (DT). Further, in the setting register 36, a rule for each image identifier IMG-ID is previously determined.

For example, in the example illustrated in FIGS. 2 and 3, the data extraction circuit 35a can acquire the pixel data PD and thus the image data IMG by extracting the line data LD input within the assert period of the data enable signal DEN. Note that the line data LD may more specifically include various types of additional information such as padding data in addition to the image data IMG. On the other hand, on the basis of the specification, it is previously determined which part includes what type of additional information. Accordingly, a rule for excluding such additional information is previously determined by the setting register 36. The data extraction circuit 35a extracts only the image data IMG on the basis of the rule.

The data extraction circuit 35a asserts the enable signal EN in a period during which the image data IMG is being extracted. The address generator 37 sequentially generates an address signal ADR by performing, for example, a counting operation within an assertive period of the enable signal EN. From the setting register 36, the address generator 37 acquires a preset start address SADR for each image identifier IMG-ID, in other words, for each image data IMG.

The address generator 37 sequentially generates the address signal ADR while using the acquired start address SADR as an origin. More specifically, the address generator 37 sequentially generates the address signal ADR while using a start address with offset as the origin resulted from sequential addition of the offset to the start address SADR every time the line changes. As a result, the image data IMG extracted by the data extraction circuit 35a is written into an address based on the address signal ADR generated by the address generator 37 in the memory MEM. The monitor circuit 30a includes an expected value register 41, a line counter 42, and a comparator 43, as illustrated in FIG. 4B. The expected value register 41 outputs a preset expected value EV regarding the number of lines, for each image identifier IMG-ID on the basis of the image identifier IMG-ID. Note that the expected value register 41 may be a part of the setting register 36. The line counter 42 receives, as its input, the line synchronization signal Hsync included in the image composite signal IMCS, and counts the number of times of the input of the line synchronization signal Hsync. Specifically, the line counter 42 counts the number of times of the input of the line synchronization signal Hsync within an assertive period of the frame synchronization signal Vsync included in the image composite signal IMCS.

The comparator 43 compares a count value CV counted by the line counter 42 with the expected value EV output from the expected value register 41. If the count value CV and the expected value EV do not match each other, the comparator 43 outputs an error signal ERR. For example, in the example illustrated in FIGS. 2 and 3, “n” is preset as the expected value EV, and the comparator 43 outputs the error signal ERR if the count value CV is not “n”.

Accordingly, it can be verified whether or not the image data IMG has been correctly acquired from the sensor 11. If the error signal ERR is output from the comparator 43, for example, the processor PRC stops the image processing or the image recognition processing onto the image data IMG to be a target of the error signal ERR. As a result, a situation where the processor PRC performs the image processing or the image recognition processing based on the deteriorated image data can be prevented, and the sufficient functional safety can be achieved particularly in the in-vehicle system or the like.

As another method, a method of, for example, counting the number of pixel data PD included in image data IMG instead of the line synchronization signal Hsync is also considerable. However, depending on the image processing system, for example, the predetermined number of pixel failures may be permitted in the image sensor. In this case, it is not easy to determine the expected value. From this viewpoint, it is useful to use the method of counting the line synchronization signal Hsync.

### Main Effects of First Embodiment

As described above, the method according to the first embodiment includes: the line counter that counts the line synchronization signal output from the reception interface circuit; and the comparator that compares its count value with the expected value. As a result, it can be typically verified whether or not the image data has been correctly acquired from the sensor has been able to be correctly acquired. In other words, a failure of the sensor itself and a failure on the path leading from the sensor to the reception interface circuit can be detected.

### SECOND EMBODIMENT

### Outline of Reception Interface Circuit

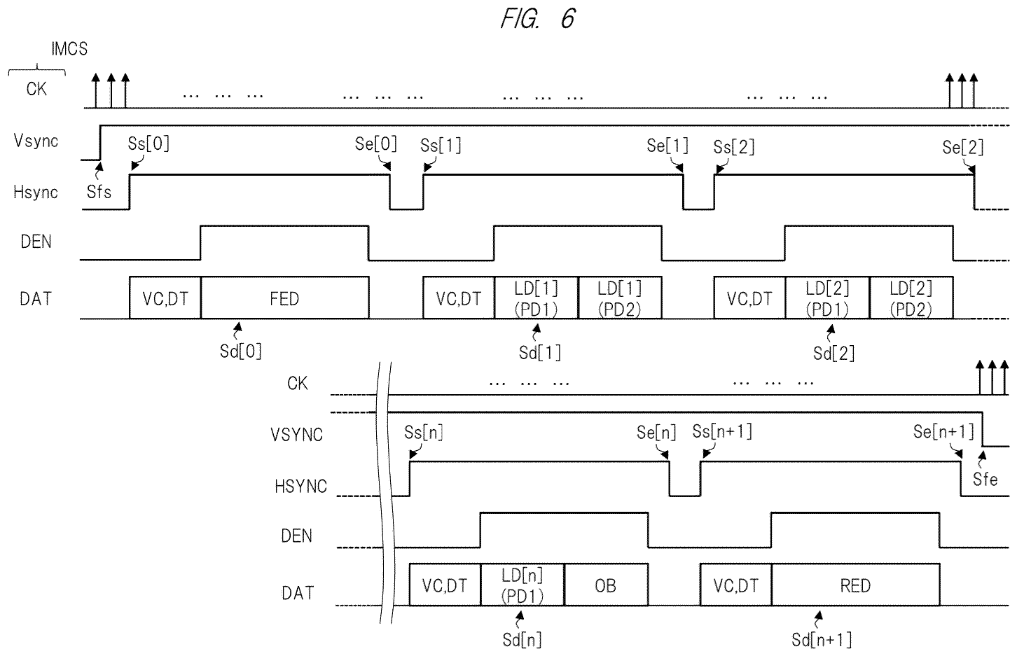

FIG. 5 is a schematic diagram illustrating a configuration example of the packet PKT received by the reception interface circuit 20 illustrated in FIG. 1 in a semiconductor device according to a second embodiment. FIG. 6 is a timing chart illustrating a conceptual configuration example of the image composite signal IMCS output from the reception interface circuit 20 illustrated in FIG. 1 in the semiconductor device according to the second embodiment.

The configuration example illustrated in FIG. 5 differs from the configuration example illustrated in FIG. 2 in the following points. A first difference is that the reception interface circuit 20 receives front embedded data FED as line data LD[0] and receives rear embedded data RED as line data LD[n+1]. The front embedded data FED and the rear embedded data RED are each data to be added by the sensor 11, the serializer in the transmission path, or the like. As its specific example, meta data including various types of product-specific information typified by a setting value of the image sensor or the like is exemplified.

As a second difference, the reception interface circuit 20 receives a plurality of, here, two image data IMG1 and IMG2 in the same frame. Accordingly, each of line data LD[1] to LD[n−1] includes the two image data IMG1 and IMG2, specifically includes two types of pixel data PD1 and PD2 respectively configuring the two image data IMG1 and IMG2. That is, the line data LD[1] includes the line data LD[1] (PD1) made of the pixel data PD1 in the image data IMG1 and the line data LD[1] (PD2) made of the pixel data PD2 in the image data IMG2. The two image data IMG1 and IMG2 are data that are different in, for example, an exposure amount (exposure).

As a third difference, the reception interface circuit 20 receives optical black data OB used in black level correction as the line data LD[n] of the n-th line. In this example, the image data IMG1 is made of “n” lines, and the image data IMG2 is made of “n−1” lines. The optical black data OB is stored in a vacant region corresponding to the image data IMG2 that does not exist in the line data LD[n] of the n-th line.

The reception interface circuit 20 receives such a packet PKT, and conceptually outputs the image composite signal IMCS as illustrated in FIG. 6. A configuration of the image composite signal IMCS illustrated in FIG. 6 is basically similar to the configuration illustrated in FIG. 3. However, FIG. 6 differs from FIG. 3 in the following points due to the above-described differences in the packet PKT.

A first difference is that the reception interface circuit 20 outputs the front embedded data FED as the line data LD[0] (step Sd[0]) in a first assertive period (in step Ss[0], step Se[0]) of the line synchronization signal Hsync. The reception interface circuit 20 outputs the rear embedded data RED as the line data LD[n+1] (in step Sd[n+1]) in a last assertive period (in step Ss[n+1], step Se[n+1]) of the line synchronization signal Hsync.

A second difference is that the reception interface circuit 20 outputs the two types of pixel data PD1 and PD2 respectively configuring the two image data IMG1 and IMG2 in each of pieces LD[1] to LD[n−1] of the line data of the first line to the “n−1”-th line (illustration of LD[n−1] is omitted) (in steps Sd[1], Sd[2], . . . ). A third difference is that the reception interface circuit 20 outputs the pixel data PD1 configuring the image data IMG1 and the optical black data OB as the line data LD[n] of the n-th line (in Step Sd[n]).

That is, the reception interface circuit 20 does not affect a content of the line data LD. Accordingly, the reception interface circuit 20 outputs the embedded data (FED and RED), the image data IMG, the optical black data OB, or the like as the line data LD within the assertive period of the data enable signal DEN without distinguish such data.

In recent years, the MIPI CSI-2 standards are compatible with 16 virtual channels (VC) that are 16 sensors 11 and 2¹⁶ types of image formats that are 2¹⁶ types of data types (DT) in view of a surround view system or the like. Each of the sensors 11 can generate, for example, four types of image data IMG that differ in the exposure amount (exposure) at maximum, that is, compatible with four exposure channels (EC). On the basis of these matters, the number of the types of the image data IMG transmitted and received by the interface circuit can be <VC×EC×DT>=<16×4×65535> at maximum.

In order to efficiently transfer a wide variety of image data IMG within a limited resource and within a limited time period, the plurality of image data IMG1 and IMG2 may be multiplexed and transferred in the same line data LD as illustrated in FIG. 5. The line data LD can also include the embedded data (FED and RED), the optical black data OB, and the like as the additional information in addition to the image data IMG1 and IMG2.

In such a case, in the method of counting the line synchronization signal Hsync included in the image composite signal IMCS as described in the first embodiment, it is difficult to verify whether or not the image data IMG has been correctly acquired. That is, as clearly seen from FIG. 6, the additional information is also counted, and thus, the counting is performed without distinguishing the image data IMG1 and IMG2. Thus, for example, even when similar additional information in FIG. 2 is included, the normal verification can be made difficult. Therefore, it is useful to use the capture circuit 21 as described below.

### Details of Capture Circuit

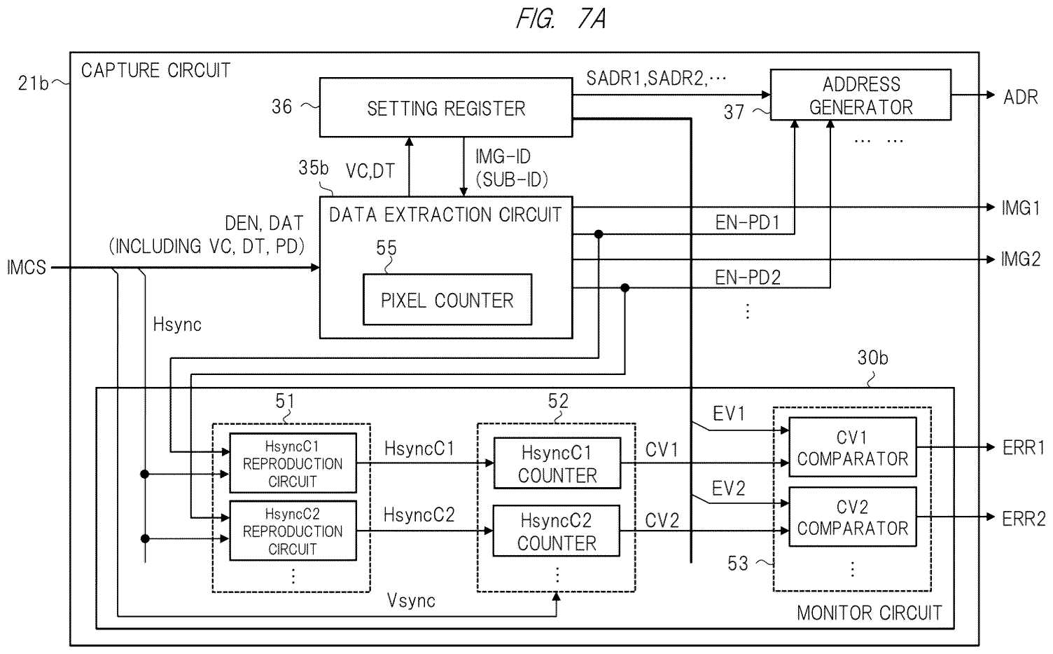

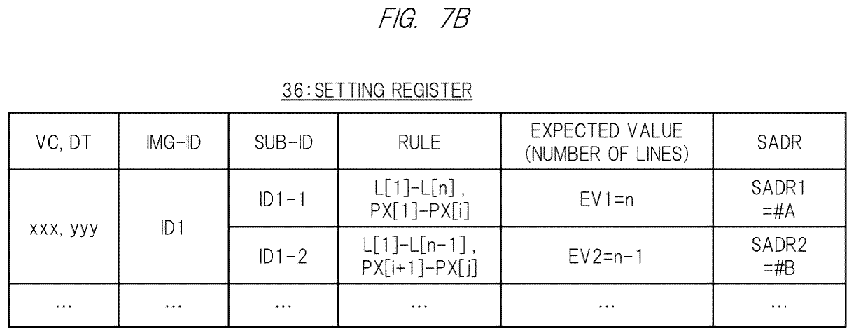

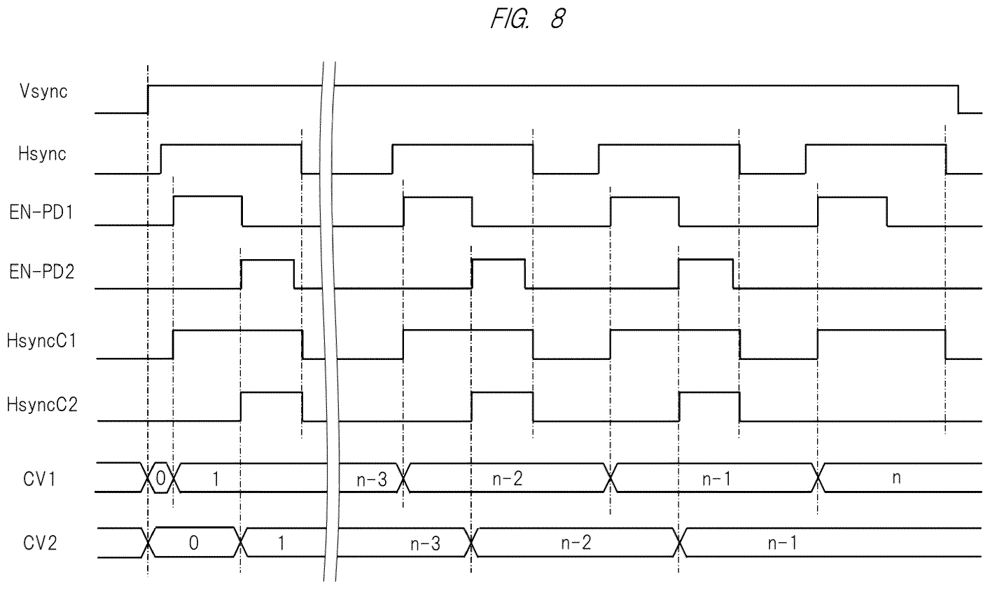

FIG. 7A is a circuit block diagram illustrating a configuration example of the capture circuit 21 illustrated in FIG. 1 in the semiconductor device according to the second embodiment. FIG. 7B is a schematic diagram illustrating an example of a content held in a setting register 36 illustrated in FIG. 7A. A capture circuit 21b illustrated in FIG. 7A includes a data extraction circuit 35b, the setting register 36, and an address generator 37, as similar to the case illustrated in FIG. 4A. The capture circuit 21b includes a monitor circuit different from the case illustrated in FIG. 4B.

The data extraction circuit 35b extracts the image data IMG from the plurality of line data LD on the basis of the preset rule as similar to the case illustrated in FIG. 4A. More specifically, the data extraction circuit 35b includes, for example, a pixel counter 55, and thus, individually extracts the image data IMG1 and the image data IMG2, i.e., the pixel data PD1 and pixel data PD2. The data extraction circuit 35b asserts an enable signal EN-PD1 in an extraction period of the image data IMG1, and asserts an enable signal EN-PD2 in an extraction period of the image data IMG2.

Here, in the setting register 36, “ID1” as the image identifier IMG-ID is linked with the combination of the value of the virtual channel (VC) and the value of the data type (DT) as illustrated in FIG. 7B. Further, “ID1-1” and “ID1-2” as two sub-image identifiers SUB-IDs are linked with “ID1”. The rule, the expected value EV of the number of lines, and the start address SADR are preset for each of the sub-image identifiers “ID1-1” and “ID1-2”. For example, in the rule in the sub-image identifier “ID1-1”, an instruction to extract a first pixel PX[1] to an i-th pixel PX[i] on a first line L[1] to an n-th line L[n] is issued.

On the other hand, in the rule in the sub-image identifier “ID1-2”, an instruction to extract an “i+1”-th pixel PX[i+1] to a j-th pixel PX[j] on a first line L[1] to an “n−1”-th line L[n−1] is issued. The pixel data that is extracted while following this rule is image data to be stored in a memory MEM, i.e., image data to be an image processing target. The expected value EV represents the number of lines in one frame of the image data to be the image processing target.

In the sub-image identifier “ID1-1”, an expected value EV1 is set to “n”, and a start address SADR1 is set to “#A”. On the other hand, in the sub-image identifier “ID1-2”, an expected value EV2 is set to “n−1”, and a start address SADR2 is set to “#B”. The data extraction circuit 35b operates while following the rule, and thus, can extract the pixel data PD1, i.e., the image data IMG1, and the pixel data PD2, i.e., the image data IMG2 illustrated in FIG. 6. Note that the data extraction circuit 35b is specifically made of a combination of various filters such as a filter that extracts the line data LD in a predetermined range, a filter that extracts the pixel data PD in the predetermined range, and a filter that excludes the predetermined range.

The address generator 37 sequentially generates an address signal ADR by performing a counting operation within the assertive period of the enable signal EN-PD1 while using “#A” as the start address SADRI set by the setting register 36 as an origin. The address generator 37 sequentially generates an address signal ADR by performing a counting operation within the assertive period of the enable signal EN-PD2 while using “#B” as the start address SADR2 set by the setting register 36 as an origin.

On the other hand, the monitor circuit 30b includes a synchronization signal reproduction circuit 51, a line counter 52, and a comparator 53. The synchronization signal reproduction circuit 51 links a line synchronization signal for counting newly generated for each line with the image data IMG extracted by the data extraction circuit 35b. Specifically, the synchronization signal reproduction circuit 51 links a line synchronization signal HsyncC1 and a line synchronization signal HsyncC2 as the line synchronization signals for counting, respectively, with the image data IMG1 and the image data IMG2 extracted for each line.

The line counter 52 receives, as its i input, the line synchronization signal for counting from the synchronization signal reproduction circuit 51, and counts the number of times of the input of the line synchronization signal for counting. Specifically, the line counter 52 receives, as its input, the line synchronization signals HsyncC1 and HsyncC2 for counting, and individually counts each of the numbers of times of the input of the line synchronization signals HsyncC1 and HsyncC2, as count values CV1 and CV2.

The comparator 53 compares the count value CV counted by the line counter 52 with a preset expected value EV of the number of lines for the image data IMG while using the expected value EV, and outputs the error signal ERR if the count value CV and the expected value EV do not match each other. Specifically, from the setting register 36, the comparator 53 acquires the preset expected values EV1 and EV2, respectively, for the image data IMG1 and IMG2. Then, the comparator 53 compares the count value CV1 of the line synchronization signal HsyncC1 with the expected value EV1, and outputs an error signal ERR1 if the count value CV1 and the expected value EV1 do not match each other. Similarly, the comparator 53 compares the count value CV2 of the line synchronization signal HsyncC2 with the expected value EV2, and outputs an error signal ERR2 if the count value CV2 and the expected value EV2 do not match each other.

FIG. 8 is a timing chart illustrating a main operation example of the monitor circuit 30b illustrated in FIG. 7A. The monitor circuit 30b receives, as its input, a frame synchronization signal Vsync and a line synchronization signal Hsync that are included in the image composite signal IMCS and the enable signals EN-PD1 and EN-PD2 output from the data extraction circuit 35b. As described above, the enable signal EN-PD1 is asserted in an extraction period of the pixel data PD1, and the enable signal EN-PD2 is asserted in an extraction period of the pixel data PD2.

The synchronization signal reproduction circuit 51 generates, for example, the line synchronization signals HsyncC1 and HsyncC2 for counting on the basis of the enable signals EN-PD1 and EN-PD2 and the line synchronization signal Hsync. In this example, the synchronization signal reproduction circuit 51 generates the line synchronization signal HsyncC1 for counting to be set and reset, respectively, at a rising edge of the enable signal EN-PD1 and a falling edge of the line synchronization signal Hsync.

Similarly, the synchronization signal reproduction circuit 51 generates the line synchronization signal HsyncC2 for counting to be set and reset, respectively, at a rising edge of the enable signal EN-PD2 and a falling edge of the line synchronization signal Hsync. As a result, even if such an operation that the enable signals EN-PD1 and EN-PD2 are temporarily negated in a period of several pixels is performed, the line synchronization signals HsyncC1 and HsyncC2 for counting not causing an inconvenience can be generated.

The line counter 52 outputs the count value CV1 by counting the number of times of the input of the line synchronization signal HsyncC1 for counting within an assertive period of the frame synchronization signal Vsync. Similarly, the line counter 52 outputs the count value CV2 by counting the number of times of the input of the line synchronization signal HsyncC2 for counting within an assert period of the frame synchronization signal Vsync. The enable signals EN-PD1 and EN-PD2 are respectively asserted in periods during which the pixel data PD1 and PD2 are extracted. The extracted pixel data PD1 and PD2 are each the image data to be stored in the memory MEM, in other words, the image data to be the image processing target excluding the additional information such as padding data unnecessary for the image processing. Therefore, the count value CVI within the assertive period of the frame synchronization signal Vsync is equivalent to the number of lines of the image data IMG1 to be stored in the memory MEM, that is the image data IMG1 to be the image processing target. Similarly, the count value CV2 within the assertive period of the frame synchronization signal Vsync is equivalent to the number of lines of the image data IMG2 to be stored in the memory MEM, that is the image data IMG2 to be the image processing target.

Therefore, it is found that, if the count value CV is equal to the expected value EV, the rule-based image data identified by the image identifier is extracted from the image data acquired by the sensor 11 and is stored in the memory MEM. In other words, it is found that, if the count value CV is equal to the expected value EV, the image data to be the image processing target can be correctly acquired from the image data acquired by the sensor 11. In this example, if the count value CVI and the count value CV2 at a time point where the frame synchronization signal Vsync is negated are respectively “n” and “n−1”, the comparator 53 does not output the error signals ERR1 and ERR2.

On the other hand, the count value CV does not match the expected value EV if the line data has been missing in the path leading from the sensor 11 to the reception interface circuit 20 or if the image data to be stored in the memory has failed to be correctly extracted from the image data acquired via the reception interface circuit 20. In this case, the comparator 53 outputs the error signal ERR.

### Main Effects of Second Embodiment

As described above, when a method according to the second embodiment is used, similar effects to the various effects described in the first embodiment are obtained. Typically, it can be verified whether or not the correct acquirement of the image data from the sensor has been successful. Further, even if the image data with the additional information, the multiplexed image data, or the like has been received, it can be verified whether or not the correct acquirement of each image data has been successful. In other words, it can be verified whether or not the correct reception of each image data has been successful while various transmission specifications used when the sensor transmits the image data are flexibly handled. Further, it can be verified whether or not the data has been extracted such that the image data based on the various transmission specifications is correctly stored in the memory.

### THIRD EMBODIMENT

### Outline of Reception Interface Circuit

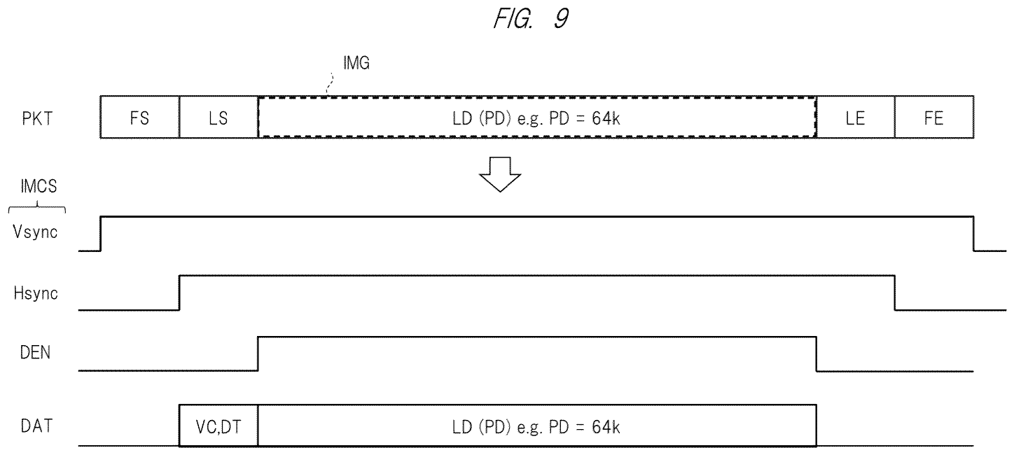

FIG. 9 is a diagram illustrating a configuration example of the packet PKT received by the reception interface circuit 20 illustrated in FIG. 1 and a configuration example of the image composite signal IMCS output from the reception interface circuit 20 in a semiconductor device according to a third embodiment. In the configuration example illustrated in FIG. 9, the frame includes the line data LD of only one line as different from the configuration example illustrated in FIG. 2. The line data LD has, for example, 64k pixel data PD. The image data IMG made of this pixel data PD is, for example, distance image data generated by a ranging sensor. That is, at least one sensor 11 illustrated in FIG. 1 is the ranging sensor.

The reception interface circuit 20 receives the packet PKT, and outputs the image composite signal IMCS as similar to the case illustrated in FIG. 3 or the like. However, in this case, in the image composite signal IMCS, the line synchronization signal Hsync is asserted only once. Accordingly, it is difficult on the basis of the line synchronization signal Hsync to sufficiently verify whether or not the correct acquirement of the image data IMG has been successful. Further, when such a large number of continuous pixel data PD are stored in the memory MEM as they are, there are concerns that address management of the memory MEM is complicated and the processing performed by the processor PRC is also complicated. Therefore, it is useful to use a capture circuit 21 as described below.

### Details of Capture Circuit

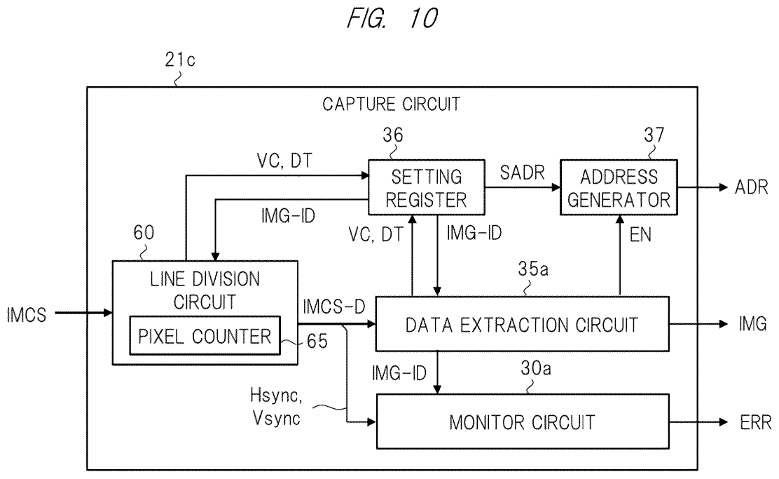

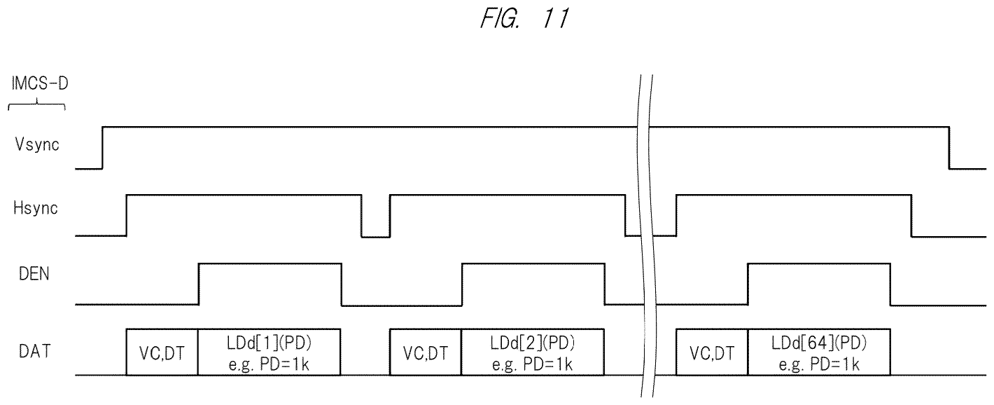

FIG. 10 is a circuit block diagram illustrating a configuration example of the capture circuit 21 illustrated in FIG.

1 in the semiconductor device according to the third embodiment. FIG. 11 is a timing chart illustrating an operation example of a line division circuit 60 illustrated in FIG. 10. A capture circuit 21c illustrated in FIG. 10 further includes the line division circuit 60 in addition to the configuration example illustrated in FIG. 4A.

The line division circuit 60 receives, as its input, the image composite signal IMCS from the reception interface circuit 20, and divides the line data LD of one line illustrated in FIG. 9 into a plurality of division line data as illustrated in FIG. 11. In this example, the line division circuit 60 divides the line data LD having the 64k pixel data PD into division line data each having 1k pixel data PD. In this case, the line division circuit 60 counts the number of the pixel data by using a pixel counter 65. Then, the line division circuit 60 outputs division line data LDd[1] to LDd[64] of 64 lines because of such line division.

Thus, the line division circuit 60 substantially converts one-dimensional image data IMG into two-dimensional image data IMG similar to that in the case illustrated in FIG. 2 or the like. Then, the line division circuit 60 links the line synchronization signal Hsync with each of the plurality of division line data LDd[1] to LDd[64]. As a result, as similar to the case illustrated in FIG. 3 or the like, the line division circuit 60 generates an image composite signal IMCS-D that has been divided and includes the frame synchronization signal Vsync, the line synchronization signal Hsync, the data enable signal DEN, and the data signal DAT, and outputs the image composite signal IMCS-D to the data extraction circuit 35a.

As similar to the data extraction circuit 35a, note that the line division circuit 60 more specifically refers to the setting register 36 while using the value of the virtual channel (VC) and the value of the data type (DT). In the setting register 36, information as to whether or not the line division is performed and a rule used in the line division are preset for the image identifier IMG-ID determined by the value of the virtual channel (VC) and the value of the data type (DT). The line division circuit 60 performs the line division on the basis of the rule. When not performing the line division, the line division circuit 60 outputs the input image composite signal IMCS as the image composite signal IMCS-D that has been divided as it is.

On the other hand, in FIG. 10, a monitor circuit 30a has a similar configuration to that illustrated in FIG. 4B. However, as different from the case illustrated in FIG. 4B, the monitor circuit 30a receives, as its input, the frame synchronization signal Vsync and the line synchronization signal Hsync that are included in the image composite signal IMCS-D that has been divided. Then, the monitor circuit 30a counts the number of times of the input of the line synchronization signal Hsync. In an example illustrated in FIG. 11, if the count value CV is not 64, the monitor circuit 30a outputs the error signal ERR.

### Main Effects of Third Embodiment

As described above, when a method according to the third embodiment is used, similar effects to the various effects described in the first embodiment are obtained. Typically, it can be verified whether or not the correct acquirement of the image data from the sensor has been successful. Further, even if one-dimensional image data is transmitted from the sensor, the one-dimensional image data is converted into two-dimensional image data and is linked with the line synchronization signal, and thus, it can be verified on the basis of the line synchronization signal whether or not the correct acquirement of the image data has been successful.

### FOURTH EMBODIMENT

### Outline of Reception Interface Circuit

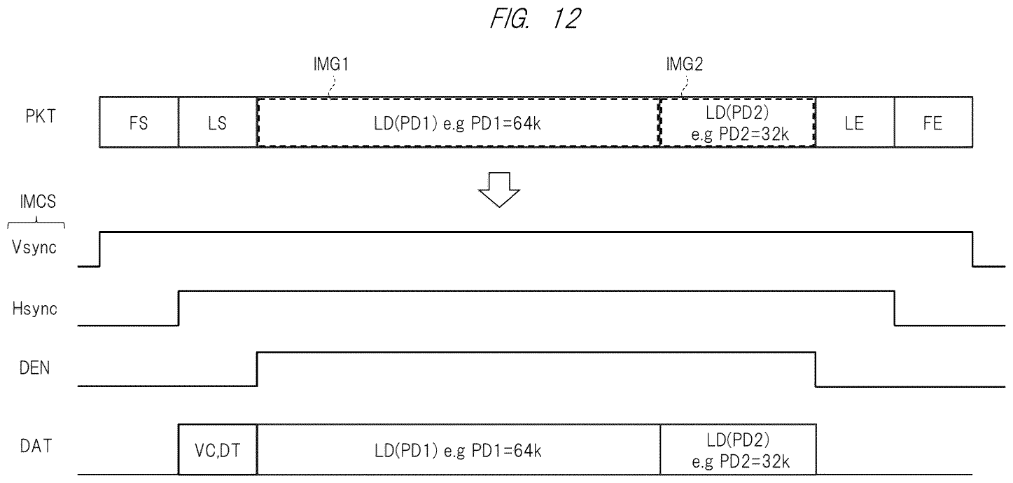

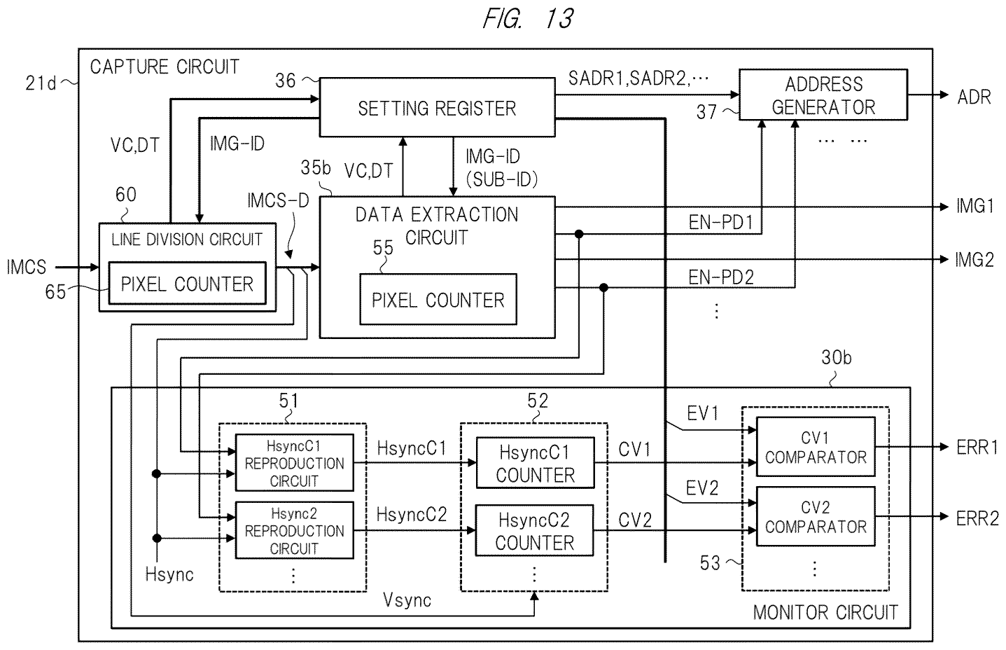

FIG. 12 is a diagram illustrating a configuration example of the packet PKT received by the reception interface circuit 20 illustrated in FIG. 1 and a configuration example of the image composite signal IMCS output from the reception interface circuit 20 in a semiconductor device according to a fourth embodiment. In the configuration example illustrated in FIG. 12, the frame includes the line data LD of only one line as similar to the configuration example illustrated in FIG. 9. However, as different from the case in FIG. 9, the line data LD has, for example, two pixel data PD1 and PD2 configuring two image data IMG1 and IMG2. In this case, the number of the pixel data PD1 is 64k, and the number of the pixel data PD2 is 32k.

### Details of Capture Circuit

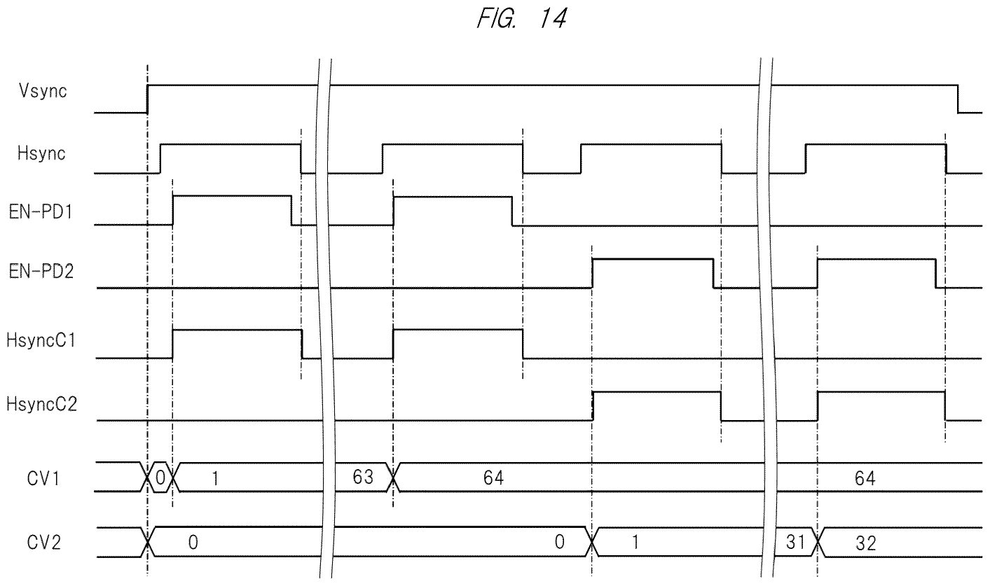

FIG. 13 is a circuit block diagram illustrating a configuration example of the capture circuit 21 illustrated in FIG. 1 in the semiconductor device according to the fourth embodiment. FIG. 14 is a timing chart illustrating an operation example of a monitor circuit 30b illustrated in FIG. 13. A capture circuit 21d illustrated in FIG. 13 further includes the line division circuit 60 as similar to that in FIG. 10 in addition to the configuration example illustrated in FIG. 7A. The line division circuit 60 is provided at a prior stage of the data extraction circuit 35b.

The line division circuit 60 receives, as its input, the image composite signal IMCS, and outputs the image composite signal IMCS-D that has been divided to the data extraction circuit 35b. The image composite signal IMCS-D that has been divided has division line data of “64+32” lines instead of the 64 lines illustrated in FIG. 11. The division line data of the 64 lines on the former part is made of the pixel data PD1, and the division line data of the 32 lines on the latter part is made of the pixel data PD2.

The monitor circuit 30b illustrated in FIG. 13 includes the synchronization signal reproduction circuit 51, the line counter 52, and the comparator 53 as similar to the case illustrated in FIG. 7A, and operates as similar to the case illustrated in FIG. 7A. However, as different from the case illustrated in FIG. 7A, the synchronization signal reproduction circuit 51 receives, as its input, the frame synchronization signal Vsync and the line synchronization signal Hsync that are included in the image composite signal IMCS-D that has been divided.

In FIG. 14, the monitor circuit 30b receives, as its input, the enable signals EN-PD1 and EN-PD2 from the data extraction circuit 35b. The enable signal EN-PD1 is a signal to be asserted 64 times on the former part of the frame, and the enable signal EN-PD2 is a signal to be asserted 32 times on the latter part of the frame.

The synchronization signal reproduction circuit 51 generates the line synchronization signals HsyncC1 and HsyncC2 for counting on the basis of the enable signals EN-PD1 and EN-PD2 and the line synchronization signal Hsync included in the image composite signal IMCS-D that has been divided. The line counter 52 outputs the count values CV1 and CV2 by counting the numbers of times of input of each of the line synchronization signals HsyncC1 and HsyncC2 for counting in the assertive period of the frame synchronization signal Vsync. In this example, if the count value CV1 and the count value CV2 at a time point where the frame synchronization signal Vsync is negated are respectively “64” and “32”, the error signals ERR1 and ERR2 are not output.

### Main Effects of Fourth Embodiment

As described above, when a method according to the fourth embodiment is used, similar effects to the various effects described in the second embodiment and the third embodiment are obtained. Typically, it can be verified whether or not the correct acquirement of the image data from the sensor has been successful. Further, as different from the case illustrated in the third embodiment, even if the multiplexed image data is received, it can be verified whether or not the correct acquirement of each image data has been successful. In the foregoing, the invention made by the inventors of the present application has been concretely described on the basis of the embodiments. However, it is needless to say that the present invention is not limited to the foregoing embodiments, and various modifications can be made within the scope of the present invention.

What is claimed is:

1. A semiconductor device comprising:
a reception interface circuit receiving a plurality of packets including a plurality of line data, respectively, and outputting an image composite signal generated by linking a line synchronization signal with each of the plurality of line data; and
a capture circuit provided at a subsequent stage of the reception interface circuit,
wherein the capture circuit includes:
a line counter receiving, as its input, the line synchronization signal included in the image composite signal, and counting the number of times of the input of the line synchronization signal; and
a comparator comparing a count value counted by the line counter with a preset expected value of the number of lines, and outputting an error signal if the count value and the expected value do not match each other.

2. The semiconductor device according to claim 1,
wherein the reception interface circuit is a circuit based on MIPI (Mobile Industry Processor Interface) CSI-2 (Camera Serial Interface 2) standards.

3. The semiconductor device according to claim 2,
wherein the image composite signal further includes a frame synchronization signal linked with the whole of the plurality of line data, and
the line counter counts the number of times of the input of the line synchronization signal within an assertive period of the frame synchronization signal.

4. The semiconductor device according to claim 1,
wherein each of the plurality of packets is a packet transmitted by an image sensor generating image data based on image capturing.

5. The semiconductor device according to claim 1,
wherein the capture circuit further includes a line division circuit dividing the line data of one line into a plurality of division line data and outputting an image composite signal that has been divided, generated by linking the line synchronization signal with each of the plurality of division line data, and
the line counter receives, as its input, the line synchronization signal included in the image composite signal that has been divided, and counts the number of times of the input of the line synchronization signal.

6. The semiconductor device according to claim 5,
wherein each of the plurality of packets is a packet transmitted by a ranging sensor generating distance image data based on a radar.

7. The semiconductor device according to claim 1, further comprising
a processor,
wherein the capture circuit writes the line data into a memory, and
the processor reads out the line data written into the memory, and performs an image processing or an image recognition processing.

8. A semiconductor device comprising:
a reception interface circuit receiving a plurality of packets including a plurality of line data, respectively, and outputting an image composite signal generated by linking a line synchronization signal with each of the plurality of line data; and
a capture circuit provided at a subsequent stage of the reception interface circuit,
wherein the capture circuit includes:
a data extraction circuit receiving, as its input, the image composite signal, and extracting image data from the plurality of line data on the basis of a preset rule;
a synchronization signal reproduction circuit linking a line synchronization signal for counting with the image data extracted by the data extraction circuit, for each line;
a line counter receiving, as its input, the line synchronization signal for counting, and counting the number of times of the input of the line synchronization signal for counting; and
a comparator using a predetermined expected value of the number of lines for the image data to compare a count value counted by the line counter with the expected value, and outputting an error signal if the count value and the expected value do not match each other.

9. The semiconductor device according to claim 8,
wherein each of one or more line data among the plurality of line data includes first image data and second image data,
the data extraction circuit individually extracts the first image data and the second image data,
the synchronization signal reproduction circuit links a first line synchronization signal and a second line synchronization signal as the line synchronization signals for counting, respectively, with the first image data and the second image data,
the line counter receives, as its input, the first line synchronization signal and the second line synchronization signal, and individually counts the number of times of the input of the first line synchronization signal and the number of times of the input of the second synchronization signal, respectively, as a first count value and a second count value, and
the comparator uses a first expected value and a second expected value as predetermined expected values of the number of lines, respectively, for the first image data and the second image data, to compare the first count value with the first expected value, and output a first error signal if the first count value and the first expected value do not match each other, and to compare the second count value with the second expected value and output a second error signal if the second count value and the second expected value do not match each other.

10. The semiconductor device according to claim 8,
wherein the reception interface circuit is a circuit based on MIPI (Mobile Industry Processor Interface) CSI-2 (Camera Serial Interface 2) standards.

11. The semiconductor device according to claim 10,
wherein the image composite signal further includes a value of a virtual channel and a value of a data type based on the MIPI CSI-2 standards,
the capture circuit previously holds the rule used in the data extraction circuit and the expected value used in the comparator for each combination of the value of the virtual channel and the value of the data type,
the data extraction circuit determines the rule on the basis of the value of the virtual channel and the value of the data type included in the image composite signal, and
the comparator determines the expected value on the basis of the value of the virtual channel and the value of the data type included in the image composite signal.

12. The semiconductor device according to claim 8,
wherein the image composite signal further includes a frame synchronization signal linked with the whole of the plurality of line data, and
the line counter counts the number of times of the input of the line synchronization signal for counting within an assertive period of the frame synchronization signal.

13. The semiconductor device according to claim 8,
wherein each of the plurality of packets is a packet transmitted by an image sensor generating image data based on image capturing.

14. The semiconductor device according to claim 8,
wherein the capture circuit further includes a line division circuit provided at a prior stage of the data extraction circuit, receiving, as its input, the image composite signal, dividing the line data of one line among the plurality of line data into a plurality of division line data, and outputting an image composite signal that has been divided, generated by linking the line synchronization signal with each of the plurality of division line data, and
the data extraction circuit receives, as its input, the image composite signal that has been divided, and extracts image data from the plurality of division line data on the basis of a preset rule.

15. The semiconductor device according to claim 14,
wherein each of the plurality of packets is a packet transmitted by a ranging sensor generating distance image data based on a radar.

16. The semiconductor device according to claim 8, further comprising
a processor,
wherein the capture circuit writes the image data extracted by the data extraction circuit into a memory, and
the processor reads out the image data written into the memory, and performs an image processing or an image recognition processing.
